(19) United States
(12) Patent Application Publication
(10) Pub. No.: US 2015/0118643 A1
(43) Pub. Date: Apr. 30, 2015

(54) ANTIBACTERIAL DENTAL CLEANING APPARATUS

(71) Applicant: Andree Myongson Lee, Los Angeles, CA (US)

(72) Inventor: Andree Myongson Lee, Los Angeles, CA (US)

(21) Appl. No.: 14/066,164

(22) Filed: Oct. 29, 2013

(51) Int. Cl. A61C 17/16

(52) U.S. Cl. CPC A61C 17/16
USPC 433/80

(57) ABSTRACT

A combination which augments and renders a forceful water stream apparatus an effective antibacterial device using only ordinary tap water. A micro-bubble generator is configured as an addition to the water stream apparatus so that the water stream comprises a large number of micro-bubbles. The micro-bubble generator produces air bubbles having diameters in the range of about 20 μm to about 50 μm. The small bubble diameter provides a high density and large number of micro-bubbles which produce many negative ions causing minute foreign particles to adsorb to the micro-bubbles and also creates a slightly alkali effect which also promotes sterilization. The micro-bubbles promote penetration into small periodontal and periimplant pockets where an ordinary water stream could not penetrate. Moreover, the ionization effect of high density micro-bubble water provides a germicidal effect which kills bacteria hidden in such pockets and in the gingival sulcus.

### BACKGROUND OF THE INVENTION

1. Field of the Invention

The present invention relates generally to dental cleaning appliances and more particularly to an anti-bacterial cleaning apparatus that employs micro-bubble technology to kill bacteria in hidden oral pockets such as those resulting from dental implant incisions and other oral surgeries as well as cleaning the gingival sulcus.

2. Background Discussion

The present disclosure is of a unique combination of an apparatus producing a narrow, pressurized stream of water used in some commercially available products for removing food particles from between teeth, and a micro-bubble generator for altering the water stream so that it comprises extremely small air bubbles which can penetrate into small oral pockets and have an antibacterial effect.

Teeth and gum maintenance is an important aspect of oral hygiene. Removing food particles from between teeth and along the gum line at the base of teeth is recommended by most dentists as at least a daily routine. Historically this procedure has been accomplished by flossing where a thin nylon string is forced between adjacent teeth to engage and remove foreign particles which could otherwise attract bacteria and cause gum inflammation and disease if left unattended. Relatively recent improvements for flossing include use of an apparatus which generates a high pressured narrow stream of water and which typically comprises a water storage tank, a pump and a tubular tip having a tapered hollow end for releasing a narrow stream of water from a hygienic jet probe which can be maneuvered in a user's mouth to direct a pressurized stream of water to force particles from between teeth. This water stream device can be effective for its limited purpose of flossing, that is, forceful removal of food particles from between adjacent teeth and along the gum line. However, there is only an indirect effect on bacteria, i.e., bacteria contained in the trapped food particles are removed, but there is no direct germicidal or antibacterial effect because normally, ordinary tap water does not kill bacteria even when applied in a forceful stream.

In the last decade or so, advances in dental procedures include surgical implants wherein a simulated tooth may be surgically substituted for a faulty natural tooth or to provide a functional “tooth” where a natural tooth has been removed or has fallen out. These tooth substitutes commonly referred to as “implants” are typically affixed to abutments or other mechanical accessories which are, in turn, embedded in the patient's dental bone tissue hidden below the gum tissue. Therefore, it is a standard part of the dental implant process to make deep incisions into the gums in order to access the bone tissue which is used to firmly secure the substitute tooth or teeth in the patient's oral cavity. Such incisions heal over time, but must nevertheless be kept clean and free of bacteria during the healing process. Moreover, periimplant pockets may result even after healing and these areas must also be kept relatively clean and free of bacteria which could otherwise work their way down to the bone tissue. Without proper care on a regular basis, implants can fail and often do over time due to the detrimental effects of bacteria on bone tissue.

Patients who use the forceful stream apparatus as their principal means for keeping such pockets clean and free of bacteria after implant surgery or other dental repair, do not adequately maintain proper oral hygiene because these products do not kill bacteria. As a result, viable and potentially dangerous bacteria remain, which can eventually cause destruction of bone tissue and implant failure. Therefore, there is an ongoing need for a remedy which would make the water stream apparatus more effective by giving it germicidal properties, but without requiring the use of antibacterial chemicals which could otherwise create operating complexities, increase costs and cause side effects such as allergic reactions in some patients. An easy to use appliance is needed to clean the gingival sulcus, that is, the region or space between a tooth and the surrounding gingival tissue as well as periodontal and periimplant pockets.

### SUMMARY OF THE INVENTION

The present invention meets the aforementioned need by providing a new combination which augments and renders a forceful water stream apparatus an effective antibacterial device using only ordinary tap water. In the presently preferred embodiment, a micro-bubble generator is configured as an addition to the water stream apparatus so that the water stream comprises a large number of micro-bubbles.

Micro-bubbles are extremely small air bubbles that can range in diameter from 1 to 999 μm. In the preferred embodiment disclosed herein the micro-bubble generator produces air bubbles having diameters in the range of about 20 μm to about 50 μm. The unusually small diameter of micro-bubbles (a cubic inch of water may contain several hundred micro-bubbles), has multiple beneficial effects. First the small diameter permits penetration into small oral pockets and spaces that ordinary bubble-free water or large conventional bubbles would not penetrate. Larger bubbles would be too big to penetrate and would be prone to actually block the entrance to such pockets and spaces Bubble-free water might penetrate further than large bubbles but would be limited by surface cohesion.

The small bubble diameter provides a high density of a large number of micro-bubbles which produce many negative ions causing minute particles to adsorb to the micro-bubbles and also creates a slightly alkali effect which also promotes sterilization. Thus, by combining a micro-bubble generator with a forceful water stream apparatus so that the stream contains a larger number of micro-bubbles, the stream is no longer limited only to mechanical effects to push food particles from between teeth. The micro-bubbles enable penetration of the stream into small incision-caused pockets as well as the gingival sulcus where an ordinary water stream could not penetrate. Moreover, the ionization effect of high density micro-bubble rater provides a germicidal effect which kills bacteria hidden in such locations.

In the preferred embodiment, the micro-bubble generator comprises a high pressure water pump (i.e., 30 psi) and a first orifice interface having a plurality of narrow orifices which are located in a connector at a sealed port of a water storage tank used by the forceful stream apparatus. A recirculation loop is formed between that tank and the micro-bubble generator pump using a return path so that micro-bubbles are continuously generated and restored in the tank during operation of the stream apparatus. In addition, a second orifice interface in the form of a tube also having a small orifice, is preferably placed into the tapered portion of the stream apparatus probe which is normally held by the user so that the narrow stream of pressurized water is close to the teeth. This second orifice interface promotes additional micro-bubble formation at or near the impingement location so that the bubble penetration and ionization effect occurs close to the pocket or space from which bacteria is to be expunged.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a plan view of an exemplary embodiment of a combined forceful stream flossing device and integrated micro-bubble generator in accordance with the present invention;

FIG. 2 is a rear view of the apparatus of FIG. 1;

FIG. 3 is a cross-sectional view of a connector used to interface the micro-bubble generator and a tank of the forceful stream flossing device;

FIG. 4 is a cross-sectional view taken along lines 4-4 of FIG. 3;

FIG. 5 is a view of the probe of the flossing device showing an orifice tube therein to further promote generating micro-bubbles from the tip thereof: and

FIG. 6 is an enlarged sectional view of the orifice tube of FIG. 5.

### DETAILED DESCRIPTION OF A PREFERRED EMBODIMENT

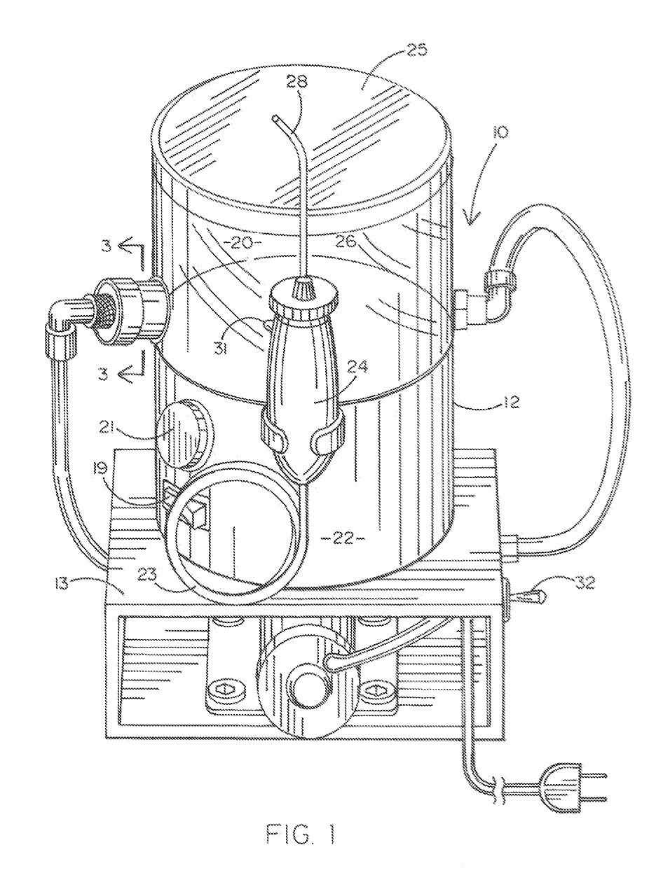

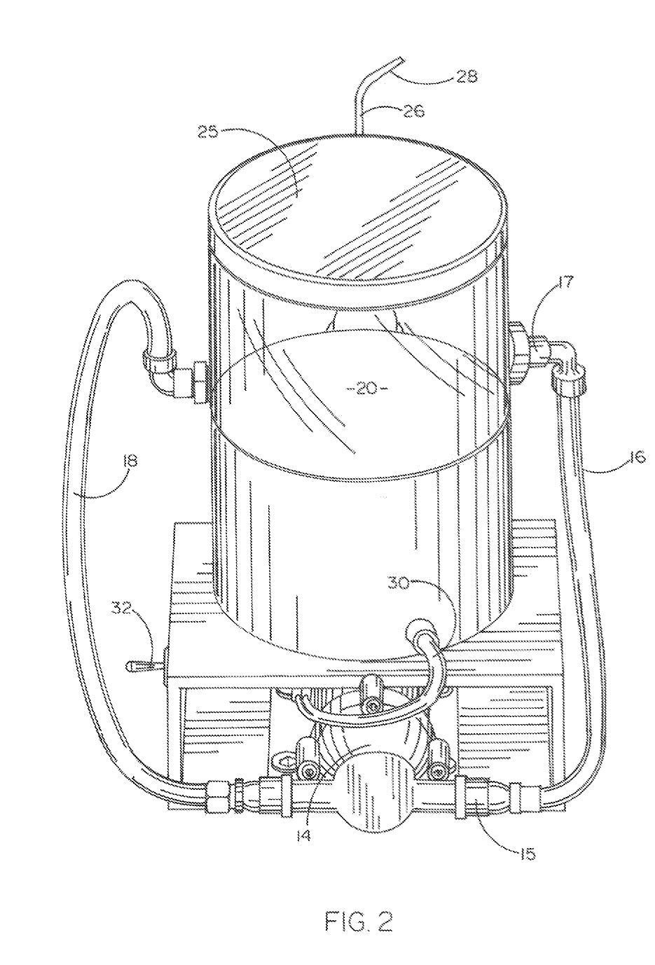

Referring to the accompanying drawings and FIGS. 1 and 2 in particular, it will be seen that a cleaning apparatus 10 comprising a flossing water stream device 12 mounted on a rectangular box-shaped fixture 13. The latter houses a micro-bubble pump 14 which has a pump connector 15 permitting the output flow of pump 14 to pass through a micro-bubble input tube 16. In the disclosed embodiment pump 14 uses a ¼ hp motor to generate a water pressure of about 30 psi. The opposite end of tube 16 is affixed to the tank 20 of water stream device 12 using an orifice configured connector described below in conjunction with FIG. 3. A return tube 18 interconnects tank 20 and pump 14 for return flow from the tank to the pump.

Flossing water stream device 12 also provides an on/off control 19, an intensity adjustment 21 and a water stream pump 22 below tank 20. Pump 22 is a conventional stream generating pump operating at a relatively low pressure and is entirely distinct from micro-bubble pump 14. A stream tube 23 interconnects pump 22 with a probe holder 24 to selectively direct a water stream through probe 26 and hygienic tip 28. A flow control 31 on probe 26 permits temporary flow stoppage during normal operation. An AC electrical power line 30 is connected to a junction at micro-bubble pump 14. Tank 20 is enclosed at its top opening with a removable cover 25 to permit easy addition of tap water to the tank. A system toggle switch 32 provides on/off control for the entire combined apparatus powered via a main AC cable 33. The invention may also be powered by a DC source such as batteries in alternative embodiments.

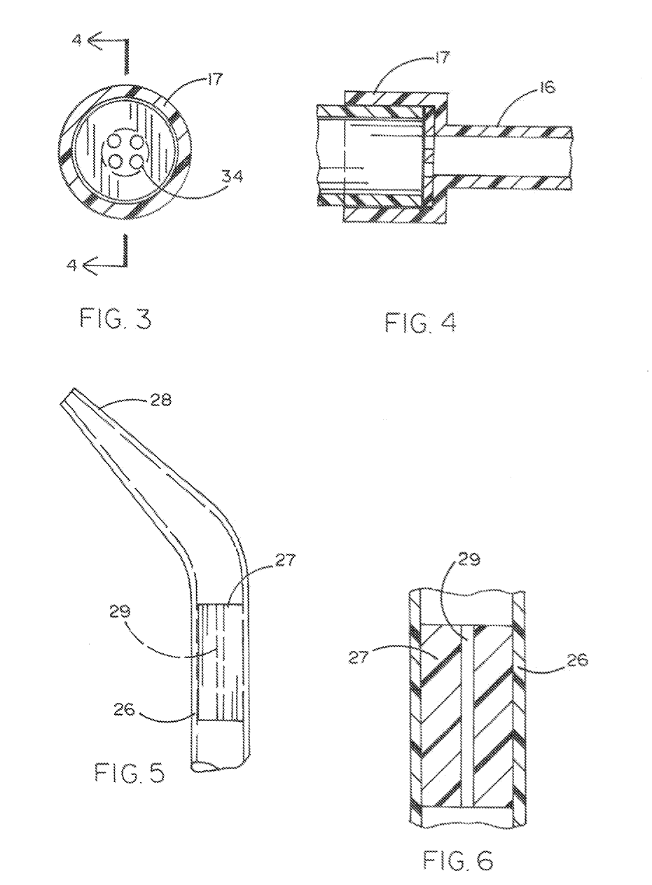

It will be understood that the water stream device may be commercially acquired as an independent unit such as the product sold under the trademark WaterPik® and then modified to incorporate micro-bubble generation to fill the tank with micro-bubble-loaded water to be applied via the probe and tip. The principal micro-bubble modifications consist of the added larger pump, the input and return tubes and two orifice devices. One such orifice device is contained in connector 17 and the other is in tip 28 and these devices are shown in FIGS. 3 and 4, respectively.

Referring to FIG. 3, it will be seen that connector 17 comprise our parallel orifices 34 each of a diameter that is approximately 1 mm. FIG. 4 shows a single orifice tube insert 27 which is located in probe 26 behind tip 28 and also comprises approximately a 1 mm orifice or flow path 29.

It will now be understood that the present disclosure relates to a new combination of water stream flossing apparatus and micro-bubble generator. The flossing apparatus has a tank of water, the content of which is forced by a first pump through the tubular tip of a hand-held probe. The micro-bubble generator produces water entrained bubbles of air having diameters preferably in the range of about 20 μm to about 50 μm and loads the bubbles into the tank of water. Such small bubbles in relative high density in the water stream, increase penetration into narrow oral pockets and produce an ionizing effect which makes the water more alkaline thereby killing bacteria.

Although an exemplary embodiment of the invention has been disclosed herein, it will be apparent that the scope hereof is to be deemed limited only by the appended claims and their equivalents.

1. An apparatus comprising the combination of a water stream flossing device and a micro-bubble generator for killing bacteria in limited access areas of the mouth by impinging a forceful water stream containing micro-bubbles in such areas;
the flossing device having a water tank and a first pump for producing a forceful stream of water though a hand-held probe;
the micro-bubble generator having a second pump having an output water flow path into said tank and having an input water flow path from said tank for continuously circulating water containing micro-bubbles between said tank and said second pump; and
at least one water flow restricting orifice located in said output water flow path between said second pump and said tank for creating micro-size air bubbles in water within said tank.

2. The apparatus recited in claim 1 wherein said second pump and said water flow restricting orifice are configured for generating micro-bubbles most of which have a diameter that is less than 100 μm.

3. The apparatus recited in claim 2 wherein said diameter is less than 50 μm.

4. The apparatus recited in claim 1 wherein said second pump operates at an output water pressure which is greater than the output water pressure of said first pump.

5. The apparatus recited in claim 4 wherein said output water pressure of said second pump is about 30 psi.

6. The apparatus recited in claim 1 wherein there are a plurality of parallel water flow restricting orifices located in said output water flow path between said second pump and said tank.

7. The apparatus recited in claim 6 wherein said plurality of parallel water flow restricting orifices comprises orifices having a diameter of about 1 mm.

8. The apparatus recited in claim 6 wherein said plurality of parallel water flow restricting orifices comprises four orifices.

9. The apparatus recited in claim 1 wherein said hand-held probe comprises a tubular flow tip having a flow path limited to a diameter of about 1 mm.

10. The apparatus recited in claim 9 wherein said flow tip flow path is restricted by an interior co-axial tube along at least a portion of its length.

11. A dental cleaning apparatus comprising:
a micro-bubble generator producing water entrained air bubbles the majority of which having a diameter that is less than about 100 μm;
a tank storing a volume of water containing said micro-bubbles;
a water stream probe creating a pressurized stream of water for impingement at locations in a user's mouth, said probe in fluid communication with said tank for producing said stream from said volume of water containing micro-bubbles.

12. The apparatus recited in claim 11 wherein said majority of micro-bubbles have a diameter that is in a range of about 20 μm to about 50 μm.
